(19) United States
(12) Patent Application Publication
(10) Pub. No.: US 2006/0196335 A1
(43) Pub. Date: Sep. 7, 2006

(54) Automated spiral potato slicing apparatus and method

(76) Inventor: Birdsall Lee Jones, Eugene, OR (US)

Correspondence Address: Spiral Spuds Machines, LLC, 180 Moore St., PO Box 601, Harrisburg, OR, 97446, US

(21) Appl. No.: 11/074,186

(22) Filed: Mar. 7, 2005

(51) Int. Cl. B26D 7/06

(52) U.S. Cl. 83/733

(57) ABSTRACT

An automated spiral potato slicer is described herein comprising: a rotating drum with cutting blade and holding vanes mounted on a housing (base); said holding vanes are supported by elastic bands that support the potato when loaded into the drum in a cutting position; a triangular shaped block attached to an air cylinder applies pressure to the potato as a drive belt makes contact with a drive pulley when the motor is engaged; the triangular block has prongs extending from it to secure the potato until its final turn in the apparatus; the thickness of the cut is controlled by the distance between the blade and the inside surface of the housing. The final result is a continuous spiral sheet with the core of the potato separated from the spiral sheet itself. The aforementioned cutting apparatus is designed to work either as a manually loaded single entry cutting devise or fully automated with the entry feeder which is longitudinally advanced to the loading feeder. The entry sensor would control the apparatus supplying the potatoes to the entry feeder. The load position sensor will stop the action of the entry feeder when activated. The potato will be advanced by the loading feeder to the load tray until the loaded sensor is activated. The loading feeder will stop; the load tray cylinder will rotate the load tray to the load potato position. When the slicer has been placed in the load position, the load apparatus will advance the potato into the slicer. The slicer rotate cylinder will place the slicer in the cut position. When the slicer has reached cut position, the push cylinder will engage the potato, forcing the prongs into the end of the potato. Simultaneously, the drive motor will start rotating the slicer. The potato will advance through the slicer by the removal of a substantially continuous spiral sheet from the end of the potato by turning the potato end until the triangular push block reaches the slicing blade. The rotating drum turns the push block by its contact with the holding vanes. The potato core may be suspended from the prongs and may be removed by the retraction of the push cylinder. When the push cylinder has retracted, the slicer will be rotated to the load position for the next cycle.

### SECTION 1

This section describes the method and components of our AUTOMATED SPIRAL POTATO SLICING APPARATUS AND METHOD to meet the following objects and improve the original invention (under U.S. Pat. No. 5,784,942):

To provide means to hold a potato during the cutting operation.

To provide a superior means of rotating the potato.

To provide separation of the core of the potato from the spiral cut product.

Separation of the core of the potato from the spiral cut product gives superior processing characteristics.

Specifically, the original cutting means included the core which had a tendency to remain uncooked during the frying operation.

### DESCRIPTION OF DRAWINGS

FIG. 1 is an end view of the present invention

FIG. 2 is a side view of the present invention

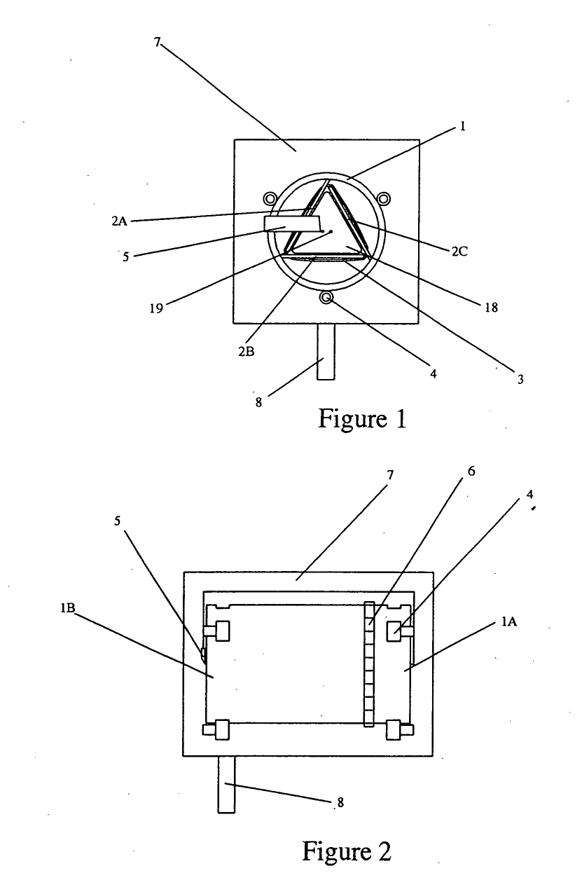

The following components are shown in FIG. 1
1. Rotating drum
2. Holding vanes
3. Elastic bands (A,B,C)
4. Support bearings
5. Cutting blade
7. Housing
8. Pivot
18. Triangular push block
19. Push block prongs

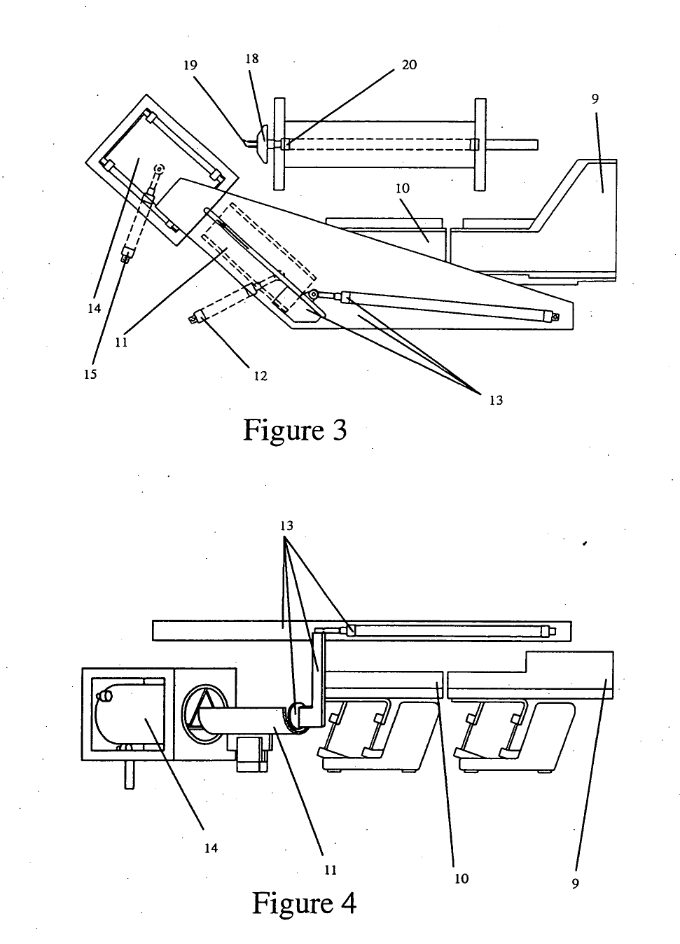

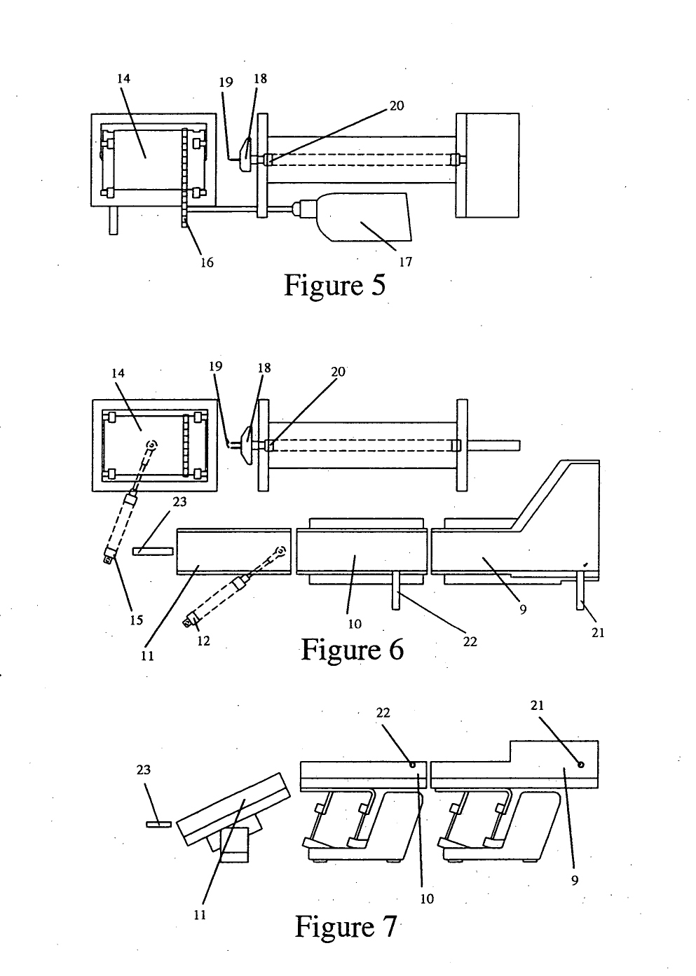

The following components are shown in FIG. 2
1. Rotating drum
4. Support bearings
5. Cutting blade
6. Drive belt
7. Housing
8. Pivot

### DESCRIPTION OF METHOD

The assembly is turned to the side to give access to the rotating drum 1. The potato is loaded into the drum 1 and is centered by the holding vanes 2. When the assembly is turned back to the cutting position, the drive belt 6 makes contact with a drive pulley. The drive motor is turned on, the drum 1 rotates, the holding vanes 2 ensure potato rotation and the cutting operation can begin. This is done by pushing the potato with a triangular shaped block 18 attached to an air cylinder. The block has prongs 19 that turn the final remaining potato end through the blade 5. The thickness of the cut is controlled by the distance between the blade 5 and the inside surface of the housing 7.

Comments
1. The assembly allows cutting the entire length of the potato. The original means required removal of the end of the potato as it could not be cut due to the potato holding and rotating method.
2. The improvements are necessary to accomplish the automation described in Section 2.
3. Prior to separating the core as mentioned above, the finished spiral cut potato product could not be successfully frozen. A description of the new process is described in Section 3.
4. The assembly has superior mechanical properties that are desirable to produce a large volume of spiral cut potato product with reduced maintenance cost. Specifically, the original means required a threaded bushing to move the potato through the cutting blade. This bushing would have experienced a high wear factor and frequent replacement would have been necessary.
5. The potato core has value as a useable by product of the process.

### SECTION 2

This section will describe the method and components of the automated prototype of the previously patented spiral potato slicing apparatus (U.S. Pat. No. 5,784,942, Jul. 28, 1998). It includes the assembly described in Section 1 which will be referred to as “slicer 14”.

The following components are shown in FIG. 3-7
9. Potato entry vibratory feeder
10. Potato loading vibratory feeder
11. Slicer load tray
12. Slicer load tray air cylinder
13. Potato load apparatus
14. Slicer
15. Slicer rotate air cylinder
16. Drive pulley
17. Drive motor
18. Triangular push block
19. Push block prongs
20. Push air cylinder
21. Potato entry photo-electric proximity sensor
22. Potato load position photo-electric proximity sensor
23. Potato loaded photo-electric proximity sensor

### DESCRIPTION OF METHOD

The potatoes are introduced to the entry feeder 9 whereas each is longitudinally advanced to the loading feeder 10. The entry sensor 21 would control the apparatus supplying the potatoes to the entry feeder 9. The load position sensor will stop the action of the entry feeder 9 when activated. The potato will be advanced by the loading feeder 10 to the load tray 11 until the loaded sensor 23 is activated. The loading feeder 10 will stop; the load tray cylinder 12 will rotate the load tray 11 to the load potato position. When the slicer 14 has been placed in the load position, the load apparatus 13 will advance the potato into the slicer 14. The slicer rotate cylinder 15 will place the slicer 14 in the cut position. It is recognized at this time the above action may repeat to position the next potato for loading thereby increasing production capability. When the slicer 14 has reached cut position, the push cylinder 20 will engage the potato, forcing the prongs 19 into the end of the potato. Simultaneously, the drive motor 17 will start rotating the slicer 14. The push block 18 will align with the triangular opening made by the holding vanes within the slicer 14. The potato will advance through the slicer 14 by the removal of a substantially continuous spiral sheet from the end of the potato. At the conclusion of the slicing operation, the prongs 19 will ensure the total slicing of the potato by turning the potato end until the push block 18 reaches the slicing blade. The rotating drum turns the push block 18 by its contact with the holding vanes. The potato core may be suspended from the prongs 19 and may be removed by the retraction of the push cylinder 20. When the push cylinder 20 has retracted, the slicer 14 will be rotated to the load position for the next cycle.

Comments
1. The essence of the final two sentences in the abstract of the original patent is not changed by the method described above. The difference is contained in the mechanical means to achieve longitudinal and rotary motion of the potato. This is further validated as an improvement to the invention in the DETAILED DESCRIPTION OF PREFERRED AND ALTERNATIVE EMBODIMENTS. Take note of lines 22-25 of this description in the original patent document.
2. It is further recognized that the automation means described above is not inclusive of the only means of automation. The apparatus described in Section 1 may work with the continuous introduction of potatoes through a tube. The longitudinal motion may be generated by water pressure within that tube.

What is claimed is:

1. A potato slicer, comprising:
a housing (base) with a rotating drum
a drum with drive belt
a drum with a cutting blade and holding vanes
a holding vane with elastic bands
a support bearing for the housing and drum
a pivot to turn housing and drum
a triangular push block
a prong on the end of push block
a drive motor
a potato entry vibratory feeder
a potato loading vibratory feeder
a slicer load tray
a slicer load tray air cylinder
a potato load apparatus
a slicer
a slicer rotate air cylinder
a drive pulley
a triangular push block
a push block prong
a push air cylinder
a potato entry photo-electric proximity sensor
a potato load photo-electric proximity sensor
a potato loaded photo-electric proximity sensor

2. A potato slicer as recited in claim 1, wherein : said means of loading the potato into the drum is centered by the vanes therein.

3. A potato slicer as recited in claim 1, wherein: said means of rotating the drum is by a belt driven motor.

4. A potato slicer as recited in claim 1, wherein: said means of pushing potato into rotating slicing blade is by a triangular push block attached to an air cylinder.

5. A potato slicer as recited in claim 1, wherein: triangular push block has prongs that turn the final remaining potato end through the blade.

6. A potato slicer as recited in claim 1, wherein: the thickness of the slices of potatoes are controlled by the distance between the blade and the inside surface of the housing.

7. A potato slicer as recited in claim 1, wherein: the core of the potato is extracted by this cutting method and apparatus.

8. A potato slicer as recited in claim 1, wherein: the potatoes are introduced to the entry feeder whereas each is longitudinally advanced to the loading feeder by a entry sensor supplying potatoes to the entry feeder.
A. The load position sensor will stop the action of the entry feeder when activated and the potato will be advanced by the loading feeder to the load tray until the loaded sensor is activated.
B. The loading feeder will stop; the load tray cylinder will rotate the load tray to the load potato position. When the slicer has been placed in the load position, the load apparatus will advance the potato into the slicer.
C. The slicer rotate cylinder will place the slicer in the cut position. When the slicer has reached cut position, the push cylinder will engage the potato, forcing the prongs into the end of the potato.
D. Simultaneously, the drive motor will start rotating the slicer. The push block will align with the triangular opening made by the holding vanes within the slicer.
E. The potato will advance through the slicer by the removal of a substantially continuous spiral sheet from the end of the potato.

9. A potato slicer as recited in claim 1, wherein: the prongs on the push block assure the potato continues to its end through the slicing blade. The potato core is detached from the prongs in the retraction of the push cylinder.
